(19) United States
(12) Patent Application Publication
(10) Pub. No.: US 2014/0263770 A1
(43) Pub. Date: Sep. 18, 2014

(54) Apparatus and Method for Separating Paper from Mixed Recyclable Materials

(71) Applicant: SUMMIT EQUIPMENT, INC., Post Falls, ID (US)

(72) Inventors: Donald G. Hissong, Post Falls, ID (US); D. Scott MacDonald, Spokane Valley, WA (US); Darren M. Peha, Spokane Valley, WA (US)

(21) Appl. No.: 13/830,482

(22) Filed: Mar. 14, 2013

(51) Int. Cl. B02C 23/14; B02C 19/00

(52) U.S. Cl. CPC B02C 23/14; B02C 19/0056
USPC 241/24.19; 241/75

(57) ABSTRACT

A paper separating apparatus is provided for mixed recyclable material. The apparatus includes a frame, an agitating roll, a first screw conveyor roll, a second screw conveyor roll, a first opening, a second opening, and at least one drive motor. Three-dimensional mixed recyclable material is delivered along the rolls from the entrance end to the exit end, and paper is dropped through one of the first opening and the second opening. A method of separating paper from three-dimensional mixed recyclable material is also provided.

### TECHNICAL FIELD

This disclosure pertains to material recycling. More particularly, this disclosure relates to apparatus and methods for separating paper from mixed recyclable materials.

### BACKGROUND OF THE INVENTION

Numerous machines have been devised for separating components of mixed recyclable materials within recycling operations. One recent technique involves single-stream recycling where an array of different recyclable materials are separated out from one another. One stage entails separating out paper from a stream of mixed recyclable material, such as plastic and other relatively three-dimensional recyclable products. Improvements are needed in this separating stage in order to reduce need for hand labor, to make the process more efficient with a higher accuracy yield, to improve initial cost, to improve maintenance cost, and to automate the process.

### SUMMARY OF THE INVENTION

A paper separating apparatus is provided for mixed recyclable material. The apparatus includes a frame, an agitating roll, at least one screw conveyor roll, a first opening, a second opening, and at least one drive motor. Three-dimensional mixed recyclable material is delivered along the rolls from the entrance end to the exit end, and paper is dropped through one of the first opening and the second opening.

According to one aspect, a paper separating apparatus is provided for mixed recyclable material. The apparatus includes a frame, an agitating roll, a first screw conveyor roll, a second screw conveyor roll, a first opening, a second opening, and at least one drive motor. The frame has an entrance end and an exit end. The agitating roll is carried for rotation in a prone position by the frame and extends between the entrance end and the exit end. The agitating roll has an array of projections extending radially outwardly from an outer surface of the agitating roll. The first screw conveyor roll is carried by the frame adjacent to and parallel with the agitating roll and has a raised helical ridge extending radially outwardly from an outer surface of the roll in one of a clockwise and a counterclockwise direction. The second screw conveyor roll is carried by the frame adjacent to and parallel with the first screw conveyor roll and has a raised helical ridge extending radially outwardly from an outer surface of the roll in one of a clockwise and a counterclockwise direction. The first opening is configured between the agitating roll and the first conveyor roll to provide a first paper withdraw slot there between. The second opening is configured between the first conveyor roll and the second conveyor roll to provide a second paper withdraw slot there between. The at least one drive motor is coupled to drive the agitator roll, the first conveyor roll, and the second conveyor roll in mutual co-rotation, a top surface of the agitating roll rotating toward the first screw conveyor roll and a top surface of the first screw conveyor roll rotating toward the second screw conveyor roll, and the helical ridges of the first conveyor roll and the second conveyor roll configured to urge mixed recyclable material above the agitating roll, the first screw conveyor roll, and the second screw conveyor roll, and delivery along the first conveyor roll and the second conveyor roll from the entrance end towards the exit end. The three-dimensional mixed recyclable material is delivered along the rolls from the entrance end to the exit end, and paper is dropped through one of the first opening and the second opening.

According to another aspect, a paper separating apparatus is provided for mixed recyclable material. The apparatus includes a frame, an agitating roll, at least one screw conveyor roll, a first opening, a second opening, and a drive motor. The frame has an entrance end, an exit end, and a side plate. The agitating roll is carried for rotation in a substantially recumbent position by the frame extending between the entrance end and the exit end. The agitating roll has an array of projections extending radially outwardly from an outer surface of the agitating roll. The at least one screw conveyor roll is carried by the frame adjacent to and parallel with the agitating roll on one side and the side plate on the other side, and has a raised helical ridge extending radially outwardly from an outer surface of the roll in one of a clockwise and a counterclockwise direction. The first opening is configured between the agitating roll and the first conveyor roll to provide a first paper withdraw slot there between. The second opening is configured alongside the first conveyor roll opposite the agitating roll. The drive motor is coupled to drive the agitator roll and the first conveyor roll in mutual co-rotation. The top surface of the agitating roll rotates toward the first screw conveyor roll, and the helical ridges of the first conveyor roll are configured to urge mixed recyclable material above the agitating roll, the first screw conveyor roll, and the second screw conveyor roll, and deliver the mixed recyclable material along the first conveyor roll and the second conveyor roll from the entrance end towards the exit end. Wherein three-dimensional mixed recyclable material is delivered along the rolls from the entrance end to the exit end, and paper is dropped through one of the first opening and the second opening.

According to yet another aspect, a method is provided for separating paper from three-dimensional recyclable material. The method includes: providing an agitating roll adjacent at least one screw conveyor roll supported in a prone rotatable position by a frame with a paper withdraw slot provided there between and driven in co-rotation by a motor; rotating the agitating roll and the at least one screw conveyor roll in co-rotation; while rotating, delivering mixed recyclable material along the entrance end of the agitating roll and the at least one screw conveyor roll; dropping paper between the rolls through the paper withdraw slot; and translating three-dimensional recyclable material atop and along the rolls from an entrance end to an exit end by action of the at least one screw conveyor roll.

### BRIEF DESCRIPTION OF THE DRAWINGS

Preferred embodiments of the disclosure are described below with reference to the following accompanying drawings.

FIG. 1 is perspective view from above of a paper separating apparatus for mixed recyclable materials along the exit end according to one aspect.

FIG. 2 is a perspective view from above of the paper separating apparatus of FIG. 1 along the entrance end.

FIG. 3 is a plan view of the paper separating apparatus of FIGS. 1 and 2.

FIG. 4 is a vertical downstream elevational view from the exit end of the paper separating apparatus of FIGS. 1-3.

FIG. 5 is a vertical upstream elevational view from the entrance end of the paper separating apparatus of FIGS. 1-4.

### DETAILED DESCRIPTION OF THE PREFERRED EMBODIMENTS

This disclosure is submitted in furtherance of the constitutional purposes of the U.S. Patent Laws “to promote the progress of science and useful arts” (Article 1, Section 8).

In FIG. 1, a representation of an illustrative paper separating apparatus for mixed recyclable materials is shown and identified by reference numeral 10. More particularly, a horizontal conveyor 12 is provided adjacent an upstream, or entrance end 23 of separating apparatus 10. Conveyor 12 delivers a single stream of mixed recyclable material 14 including three-dimensional waste product 15, such as plastic containers, bottles and metal cans, and paper 16. An output bin 18 is provided adjacent a downstream, or exit end 25 of separating apparatus 10. A paper bin 20 is provided beneath separating apparatus 10 configured to collect waste paper which is dropped through separating apparatus 10 while three-dimensional product 15 within mixed recyclable material 14 is conveyed from entrance end 23 to exit end 25 for delivery into output bin 18.

As shown in FIG. 1, paper mixed recyclable material separating apparatus 10 includes a frame 22 comprising an arrangement of steel beams and a cover, including side plates 27 and 29 and top shelf plates 31 and 33. Frame 22 supports two arrays of rolls 24, 28, 32 and 26, 30, 34 for rotation relative to frame 22, which are configured in mirror image arrangement to one another. Rolls 24, 28, 32 and 26, 30, 34 are carried by frame 22 in a relatively prone, substantially recumbent, or substantially horizontal position. Optionally, one or more (including all) of rolls 24, 28, 32 and 26, 30, 34 can be pitched up or down (from entrance end 23 to exit end 25) at an angle. As used herein the term “prone” is not intended to be limited to horizontal, but is intended to include slightly inclined and moderately pitched configurations up to 44 degrees angle. A portion of frame 22 comprising an angle divider, or deflector 35 is operative to split a stream of mixed recyclable material 14 between the two arrays of rolls 24, 28, 32 and 26, 30, 34 in order to separate out paper 16 from three-dimensional product 15 within mixed recyclable material 14. In operation, conveyor 12 delivers mixed recyclable material 14 at a metered rate onto separating apparatus 10 in order to separate out paper 16 from mixed recyclable material 14 where it is accumulated in bin 20. Optionally, mixed recyclable material 14 can be dropped, in a metered manner, into the upstream, or entrance end 23 of separating apparatus 10 using a front end loader, backhoe loader, or other suitable means for delivering a stream of mixed recyclable material into apparatus 10.

As seen in FIG. 1, rolls 26, 30 and 34 are driven to rotate in a clockwise direction, while rolls 24, 28 and 32 are driven to rotate in a counterclockwise direction, so as to drive mixed recyclable material in both directions outwardly from angle deflector 35. Furthermore, rolls 24 and 26 each comprise an agitating roll having an array 36 and 38, respectively, of shark-fin shaped perturbations, or projections 40 and 42 extending outwardly from an outer cylindrical surface. Perturbations 40 and 42 are configured to agitate lightweight three-dimensional product 15 of mixed recyclable material 14, moving three-dimensional product, such as empty plastic milk jugs and cans, outwardly onto successively adjacent first screw conveyor rolls 28 and 30 and second screw conveyor rolls 32 and 34, respectively. First and second screw conveyors 28, 30 and 32, 34 each have a helical ridge 44, 46 and 48, 50 raised radially from an outer surface of each respective roll 24, 30 and 32, 34.

As shown in FIGS. 1 and 2, helical ridges 44, 46 and 48, 50 serve as an Archimedes screw, delivering product 15 above rolls 28, 30 and 32, 34 (as well as on rolls 24 and 26) from entrance end 23 and toward exit end 25 where they are dropped into output bin 18 for collection and periodic removal. Paper 16 falls through gaps provided between adjacent rolls 24, 28; 26, 30; 28, 32; 30, 32 forming individual openings, or slots 41, 43, 45, 47 along a nip provided between adjacent rolls. Furthermore, similar gaps are provided between roll 32 and side plate 27, as well as roll 34 and side plate 34 comprising openings 49 and 51, respectively. According to one construction, helical ridges 44, 46 and 48, 50 are formed from one or more sections of cylindrical steel rod having a textured outer surface. Optionally, the steel rod can have a smooth outer surface. Such steel rod is then bent into a helical configuration and welded to an outer surface of each roll. Optionally, a steel rod with square or rectangular cross-section is formed and welded onto each roll. Further optionally, such steel rod configurations can have textured or rough outer surfaces. Even further optionally, rolls 32 and 34 can omit helical ridges 48 and 50, providing a smooth outer cylindrical surface, or a textured outer surface.

As seen in FIGS. 1 and 3, exit ends 25 of rolls 24, 26, 28, 30, 32 and 34 are supported for rotation in individual ball bearing assemblies 52, 54, 56, 58, 60 and 62, respectively, by central end shafts 64, 66, 68, 70, 72 and 74. Likewise, as seen in FIG. 2, entrance ends 23 of rolls 24, 26, 28, 30, 32 and 34 are supported for rotation in individual cylindrical ball bearing assemblies 53, 55, 57, 59, 61 and 63, respectively, by central end shafts 65, 67, 69, 71, 73 and 75. Optionally, bearings 52-63 can be provided by any suitable form of bearing or bushing, such as greased bronze bushings. In one case, end shafts 53, 55, 57, 59, 61 and 63 and 64, 66, 68, 70, 72 and 74 are discrete shaft end pieces that are welded onto a respective entrance end 23 and exit end 25 of rolls 24, 26, 28, 30, 32 and 34, wherein each roll is made from a steel cylindrical pipe have cylindrical end caps welded onto the pipe at each end. Alternatively, a steel rod can extended coaxially within an entire length of each roll 24, 26, 28, 30, 32 and 34 and through opposed cylindrical end plates to which each rod is welded.

As shown in FIGS. 2 and 5, rolls 24, 28 and 32 are driven in clockwise co-rotation (as seen end view in FIG. 5) by a chain drive gear assembly 76 and rolls 26, 30 and 34 are driven in counterclockwise co-rotation by another chain drive gear assembly 77. Chain drive assemblies 76 and 77 are coupled together in fluid drive relation via a hydraulic line 90 with a hydraulic motor 78 and 79 of assemblies 76 and 77, respectively, receiving a supply of hydraulic fluid via hydraulic lines 88 and 89 from a source, such as a hydraulic power unit. One suitable hydraulic power unit is a 20 hp electric motor, driving 12 GPM hydraulic pump, supplying pressurized hydraulic fluid to a pair of 11.6 CID hydraulic motors 78 and 79, moderated by a hydraulic flow control.

Chain drive assemblies 76 and 77 each include individual chain sprockets 82, 84, 86 and 83, 85, 87 (see FIG. 2) affixed onto each respective end shaft 65, 69, 73 and 67, 71, 75. A chain 80 and 81 couples together sprockets 82, 84, 86 and 83, 85, 87, respectively, for co-rotation responsive to hydraulic drive motors 76 and 77 which are each affixed onto an end of shaft 65 and 67, respectively, as shown in FIG. 2.

FIG. 4 depicts separating apparatus 10 in operation, delivering three-dimensional recycling product 15 over and along rolls 24, 28, 32 and rolls 26, 30, 34 from entrance end 23 to exit end 25 (see FIG. 1). In the process, paper 15 is separated from recycling product 15 by passing through a gap provided by one of openings, or slits 41, 43, 45, 47, 49 and 51 down and into paper bin 20 (see FIG. 20) for collection and recycling. Openings 41, 43, 45, 47, 49 and 51 provide a gap sized to allow substantially two-dimensional paper 16 to pass between adjacent rolls while preventing any three-dimensional articles, such as cans, bottles and plastic containers from passing through.

Projections 40 and 42 on rolls 24 and 26, respectively, have an arcuate leading edge with a shark-fin shaped configuration operative to agitate and jostle three-dimensional recyclable products, causing them to bounce and realign atop rolls 24, 26, 28, 30, 32 and 34, enabling relatively two-dimensional paper recycling product to drop and pass between such rolls, and between roll 32 and 34 and sidewalls 31 and 33, respectively. Optionally, projections 40 and 42 can be any shape suitable to agitate, roll, and/or manipulate mixed recyclable materials 14, and further agitate three-dimensional recyclable product 15, such as square tabs, semi-circular ribs, triangular fingers, or a roughened, or raised outer surface on rolls 24 and 26.

Modifications of the above teaching can optionally include pitching rolls 24 26, 28, 30 32 and 34, placing all of the rolls at the same height, instead of at different top surface elevations, modifying diameters of individual rolls over those shown above, varying the speeds of individual rolls relative to one another through different sized sprocket gears, changing the gap, or nip, between adjacent rolls, and using individual motors to drive each roll, such as servo drive motors. Instead of using a chain drive, other drive motors and drive mechanisms can be optionally used, such as electric motors, pneumatic motors, gear trains, and other suitable power transfer mechanisms.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

The invention claimed is:

1. A paper separating apparatus for mixed recyclable material, comprising:
a frame having an entrance end and an exit end;
an agitating roll carried for rotation in a prone position by the frame extending between the entrance end and the exit end, the agitating roll having an array of projections extending radially outwardly from an outer surface of the agitating roll;
a first screw conveyor roll carried by the frame adjacent to and parallel with the agitating roll and having a raised helical ridge extending radially outwardly from an outer surface of the roll in one of a clockwise and a counterclockwise;
a second screw conveyor roll carried by the frame adjacent to and parallel with the first screw conveyor roll and having a raised helical ridge extending radially outwardly from an outer surface of the roll in one of a clockwise and a counterclockwise;
a first opening configured between the agitating roll and the first conveyor roll to provide a first paper withdraw slot there between;
a second opening configured between the first conveyor roll and the second conveyor roll to provide a second paper withdraw slot there between; and
at least one drive motor coupled to drive the agitator roll, the first conveyor roll, and the second conveyor roll in mutual co-rotation, a top surface of the agitating roll rotating toward the first screw conveyor roll and a top surface of the first screw conveyor roll rotating toward the second screw conveyor roll, and the helical ridges of the first conveyor roll and the second conveyor roll configured to urge mixed recyclable material above the agitating roll, the first screw conveyor roll, and the second screw conveyor roll, and delivery along the first conveyor roll and the second conveyor roll from the entrance end towards the exit end;
wherein three-dimensional mixed recyclable material is delivered along the rolls from the entrance end to the exit end, and paper is dropped through one of the first opening and the second opening.

2. The paper separating apparatus of claim 1, further comprising a side plate provided adjacent and outwardly of the second conveyor roll and extending lengthwise along the second conveyor roll.

3. The paper separating apparatus of claim 2, wherein the side plate is sloped outwardly from vertical relative to the second conveyor roll.

4. The paper separating apparatus of claim 3, further comprising a third opening configured between the second conveyor roll and the side plate to provide a third paper withdraw slot there between.

5. The paper separating apparatus of claim 1, further comprising a second agitating roll carried for rotation in a prone position by the frame adjacent to and parallel with the first agitating roll and extending between the entrance end and the exit end, the agitating roll having an array of projections extending radially outwardly from an outer surface of the agitating roll;
a recyclable material divider carried by the frame above and between the first agitating roll and the second agitating roll;
a third screw conveyor roll carried by the frame adjacent to and parallel with the second agitating roll and having a raised helical ridge extending radially outwardly from an outer surface of the roll in another of a clockwise and a counterclockwise direction;
a fourth screw conveyor roll carried by the frame adjacent to and parallel with the third screw conveyor roll and having a raised helical ridge extending radially outwardly from an outer surface of the roll in another of a clockwise and a counterclockwise direction;
a fourth opening configured between the agitating roll and the first conveyor roll to provide a first paper withdraw slot there between;
a fifth opening configured between the first conveyor roll and the second conveyor roll to provide a second paper withdraw slot there between; and
at least one drive motor coupled to drive the second agitator roll, the third conveyor roll, and the fourth conveyor roll in mutual co-rotation, a top surface of the second agitator roll rotating toward the third screw conveyor roll and a top surface of the fourth screw conveyor roll rotating toward the second screw conveyor roll, and the helical ridges of the third conveyor roll and the fourth conveyor roll configured to urge mixed recyclable material above the agitating roll, the third screw conveyor roll, and the fourth screw conveyor roll, and delivery along the third conveyor roll and the fourth conveyor roll from the entrance end towards the exit end

6. The paper separating apparatus of claim 1, wherein the projections on the agitator roll comprise individual shark fin-shaped projections having an arcuate leading edge and a straight trailing edge.

7. The paper separating apparatus of claim 1, wherein the agitating roll is elevated relative to the first screw conveyor roll.

8. The paper separating apparatus of claim 7, wherein the second screw conveyor roll is elevated relative to the first screw conveyor roll.

9. A paper separating apparatus for mixed recyclable material, comprising:
a frame having an entrance end, an exit end, and a side plate;
an agitating roll carried for rotation in a substantially recumbent position by the frame extending between the entrance end and the exit end, the agitating roll having an array of projections extending radially outwardly from an outer surface of the agitating roll;
at least one screw conveyor roll carried by the frame adjacent to and substantially parallel with the agitating roll on one side and the side plate on the other side, and having a raised helical ridge extending radially outwardly from an outer surface of the roll in one of a clockwise and a counterclockwise direction;
a first opening configured between the agitating roll and the first conveyor roll to provide a first paper withdraw slot there between;
a second opening configured alongside the first conveyor roll opposite the agitating roll; and
a drive motor coupled to drive the agitator roll and the first conveyor roll in mutual co-rotation, a top surface of the agitating roll rotating toward the first screw conveyor roll, and the helical ridges of the first conveyor roll configured to urge mixed recyclable material above the agitating roll, the first screw conveyor roll, and the second screw conveyor roll, and deliver the mixed recyclable material along the first conveyor roll and the second conveyor roll from the entrance end towards the exit end;
wherein three-dimensional mixed recyclable material is delivered along the rolls from the entrance end to the exit end, and paper is dropped through one of the first opening and the second opening.

10. The paper separating apparatus of claim 9, further comprising another screw conveyor roll carried by the frame adjacent to and parallel with the first screw conveyor roll, driven in co-rotation by the drive motor, and having a raised helical ridge extending radially outwardly from an outer surface of the roll in one of a clockwise and a counterclockwise direction and carried by the frame parallel and adjacent to the agitating roll.

11. The paper separating apparatus of claim 9, wherein the second opening is configured between the first conveyor roll and the second conveyor roll to provide a second paper withdraw slot there between.

12. The paper separating apparatus of claim 9, further comprising a third opening provided between the second conveyor roll and the side plate configured to provide a third paper withdraw slot there between.

13. The paper separating apparatus of claim 12, wherein the side plate is provided adjacent and outwardly of the second conveyor roll and extends lengthwise along the second conveyor roll.

14. The paper separating apparatus of claim 13, wherein the side plate is sloped outwardly from vertical relative to the second conveyor roll.

15. A method of separating paper from three-dimensional recyclable material, comprising:
providing an agitating roll adjacent at least one screw conveyor roll supported in a prone rotatable position by a frame with a paper withdraw slot provided there between and driven in co-rotation by a motor;
rotating the agitating roll and the at least one screw conveyor roll in co-rotation;
while rotating, delivering mixed recyclable material along the entrance end of the agitating roll and the at least one screw conveyor roll;
dropping paper between the rolls through the paper withdraw slot; and
translating three-dimensional recyclable material atop and along the rolls from an entrance end to an exit end by action of the at least one screw conveyor roll.

16. The method of claim 15, wherein the agitating roll has an elevated top surface relative to an adjacent one of the at least one screw conveyor roll.

17. The method of claim 15, further comprising providing a first screw conveyor roll adjacent the agitating roll and a second screw conveyor roll adjacent the first screw conveyor roll and opposite the agitating roll, and rotating the first screw conveyor roll and the second screw conveyor roll in co-rotation with the agitating roll.

18. The method of claim 15, further comprising collecting the dropped paper beneath the agitating roll and the at least one screw conveyor roll.

19. The method of claim 18, further comprising collecting the three-dimensional recyclable material at the exit end.

20. The method of claim 15, wherein rotating the agitating roll comprises bouncing and realigning three-dimensional recyclable material atop and adjacent the agitating roll, enabling migration of paper beneath the three-dimensional recyclable material.
